(19) United States
(12) Patent Application Publication
(10) Pub. No.: US 2002/0041394 A1
(43) Pub. Date: Apr. 11, 2002

(54) Printing system using a portable terminal and method for imposing a printing charge

(76) Inventor: Satoshi Aoki, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/969,765

(22) Filed: Oct. 4, 2001

(30) Foreign Application Priority Data
Oct. 5, 2000 (JP) 2000-305946

(51) Int. Cl. G06K 1/00; G06F 15/00

(52) U.S. Cl. 358/1.15

(57) ABSTRACT

In order to print out a contents, a cellular phone sends authentication information given to a user to a contents server. The contents server authenticates the user based on the authentication information, and sends contents data for browsing to the cellular phone in a case where authentication is successful. The cellular phone sends print request information to a printer. The printer acquires contents data for print-out from the contents server in accordance with the print request information, and prints out the contents. The printer or the contents server stores data representing a printing charge per sheet, and determines a printing charge required for printing out the contents based on the stored data. The determined printing charge is imposed on the user.

### BACKGROUND OF THE INVENTION

1. Field of the Invention

The present invention relates to a method for imposing a printing charge in a printing system using a portable terminal. More particularly, the present invention relates to a method for imposing a printing charge required for printing out data in a printing system in which the data which has been retrieved using a portable terminal, such as a cellular phone, can be printed out by a printer.

2. Description of the Related Art

Portable terminals are now rapidly spreading. The most typical one is the cellular phone. And recently, uses of those portable terminals on the Internet have been developing. For example, with the use of a cellular phone, communications can be e-mailed from anywhere in real time. Information on the Internet can directly be searched, or data can be acquired by executing a function of a Web browser. Further, applications for gateway services are provided. Some of those gateway services include: a banking service in which one can check his/her balance in his/her bank account, or can transfer money to his/her account; a ticket service in which one can reserve a ticket without going to a ticket agency; and a service in which one can sell or buy financial products such as stocks, investment funds, and the like.

Another service available using a portable terminal such as a cellular phone and the like is distribution of contents. For example, NTT DoCoMo Inc. provides an i-mode™ service which is a service for getting a user connected to a network such as the Internet from a cellular phone. In the i-mode™ service, the cellular phone telecommunication network of NTT DoCoMo Inc. acts as a provider. In order to browse contents of official sites authenticated by NTT DoCoMo Inc., it is required to access the contents server (gateway server) operated by NTT DoCoMo Inc. from cellular phones corresponding to the i-mode™ service, and to get authenticated. Charges for utilizing official charge-requiring contents are collected from users by, for example, NTT DoCoMo Inc. on behalf of contents providers, together with the communication charges. NTT DoCoMo Inc. subtracts predetermined commissions from the collected charges, and pays the remainder to contents providers.

While functions of portable terminals are becoming advanced and varied as described above, various demands are arising. For example, users request a larger display of contents which users browse using their portable terminals, request to keep contents at hand as hard copies, or request to print out contents on the spot as materials for presentation at business negotiations or materials to be provided to customers.

Most of the convenience stores and offices have now introduced digital copying machines that can act as a MFP (Multi Function Peripheral). Those copying machines usually have a printing function which works in accordance with a print request from PCs or other devices. Those copying machines are often connected to a network and shared on an Intranet/the Internet. Thus, a printing system for connecting a portable terminal to such a MFP to print out data such as contents, is proposed. In this case, the MFP is to be installed in, for example, a convenience store or an office.

In such a printing system, a printing apparatus such as a copying machine receives a URL (Uniform Resource Locator) which specifies the site of the contents selected by a user, from a portable terminal. Then, the printing apparatus accesses a contents server using this URL, acquires data having high resolution from the contents server, and prints out the data. As a result, the user obtains the information which is printed out on a sheet of paper.

As described above, such a printing system is very useful, and can be used by users easily though having high-level functions. Because of this, businesses using such a printing system have potential to expand a great deal. In such a printing system, printing function providers install software in their printing apparatuses to provide such a function to users. Those printing function providers earn profits by collecting printing charges from users. However, there has been no established method for imposing printing charges in such a printing system.

### SUMMARY OF THE INVENTION

The present invention was contrived in view of the above circumstance. It is an object of the present invention to provide a method and a system for imposing a printing charge on a user in a printing system in which a printer acquires a print data in accordance with print request information sent from a portable terminal, and prints out the data.

To accomplish the above object, a printing charge imposing method according to a first aspect of the present invention is applicable to a printing system comprising a portable terminal; a printer capable of communicating data with the portable terminal and connected to a network, the printer including a display device for displaying data, and a charge collecting device for obtaining money inserted thereto; and a contents server capable of communicating data with the printer via the network, wherein; in a case where a user intends to print out contents data of the contents server which the user browses using the portable terminal, the portable terminal sends print request information for requesting print-out of the contents data to the printer; and the printer connects to the contents server via the network in accordance with the print request information, and acquires and prints out corresponding contents data for print-out, the method comprising the steps of:

pre-storing printing charge determination data for determining a printing charge;

determining the printing charge based on the printing charge determination data in accordance with that the contents data for print-out sent from the contents server has been printed out;

displaying the determined printing charge on the display device; and

obtaining money corresponding to the printing charge displayed on the display device, when such money is inserted to the charge collecting device.

A printing charge imposing method according to a second aspect of the present invention is applicable to a printing system comprising a portable terminal; a printer capable of communicating data with the portable terminal and connected to a network; and a contents server capable of communicating data with the printer via the network, wherein; in a case where a user intends to print out contents data of the contents server which the user browses using the portable terminal, the portable terminal sends print request information for requesting print-out of the contents data to the printer; and the printer connects to the contents server via the network in accordance with the print request information, and acquires and prints out corresponding contents data for print-out, the method comprising the steps of:

pre-storing printing charge determination data for determining a printing charge;

determining the printing charge based on the printing charge determination data in accordance with that the contents data for print-out sent from the contents server has been printed out;

sending data representing the determined printing charge to the portable terminal;

imposing the printing charge represented by the data sent to the portable terminal on the user of the portable terminal together with a communication charge; and

paying an amount obtained by subtracting a predetermined commission from the printing charge to a predetermined payee.

A printing charge imposing method according to a third aspect of the present invention is applicable to a printing system comprising a portable terminal; a printer capable of communicating data with the portable terminal and connected to a network; and a contents server capable of communicating data with the printer via the network, wherein; in a case where a user intends to print out contents data of the contents server which the user browses using the portable terminal, the portable terminal sends print request information for requesting print-out of the contents data to the printer; and the printer connects to the contents server via the network in accordance with the print request information, and acquires and prints out corresponding contents data for print-out, the method comprising the steps of:

pre-storing printing charge determination data for determining a printing charge;

determining the printing charge based on the printing charge determination data in accordance with that the contents data for print-out sent from the contents server has been printed out,

sending data representing the determined printing charge to the printer;

imposing the printing charge represented by the data sent to the printer on the user of the portable terminal together with a communication charge; and

paying an amount obtained by subtracting a predetermined commission from the printing charge to a predetermined payee.

A printing charge imposing method according to a fourth aspect of the present invention is applicable to a printing system comprising a portable terminal; a printer capable of communicating data with, and transferring data to the portable terminal, and connected to a network; and a contents server capable of communicating data with the printer via the network, wherein; in a case where a user intends to print out contents data of the contents server which the user browses using the portable terminal, the portable terminal sends print request information for requesting print-out of the contents data to the printer; and the printer connects to the contents server via the network in accordance with the print request information, and acquires and prints out corresponding contents data for print-out, the method comprising the steps of:

pre-storing printing charge determination data for determining a printing charge;

determining the printing charge based on the printing charge determination data in accordance with that the contents data for print-out sent from the contents server has been printed out;

sending data representing the determined printing charge to the printer;

imposing the printing charge represented by the data which has been transferred from the printer to the portable terminal on the user of the portable terminal together with a communication charge; and

paying an amount obtained by subtracting a predetermined commission from the printing charge to a predetermined payee.

A printing charge imposing method according to a fifth aspect of the present invention is applicable to a printing system comprising a portable terminal; a printer capable of communicating data with the portable terminal and connected to a network; and a contents server capable of communicating data with the printer via the network, wherein; in a case where a user intends to print out contents data of the contents server which the user browses using the portable terminal, the portable terminal sends print request information for requesting print-out of the contents data to the printer; and the printer connects to the contents server via the network in accordance with the print request information, and acquires and prints out corresponding contents data for print-out, the method comprising the steps of:

pre-storing printing charge determination data for determining a printing charge; and

determining the printing charge based on the printing charge determination data in accordance with that the contents data for print-out sent from the contents server has been printed out;

imposing the determined printing charge on the user of the portable terminal together with a communication charge; and

paying an amount obtained by subtracting a predetermined commission from the printing charge to a predetermined payee.

Each of the methods according to the first to fifth aspects of the present invention may further comprise the steps of:

sending information for requesting supply of the contents data which the user desires, and ID information and password information both given to the user to the contents server, when the user intends to browse contents represented by the contents data;

authenticating the user based on the ID information and password information sent to the contents server;

searching out contents data for browsing which represents the user's desired contents, and sending it to the cellular phone, in a case where authentication is successful;

displaying the contents represented by the contents data for browsing sent to the cellular phone;

sending the print request information including a URL (Uniform Resource Locator) specifying the contents data for print-out which represents the displayed contents to the printer;

sending information for requesting supply of the contents data for print-out, and user's ID information and password information to the contents server, in accordance with the print request information;

authenticating the user again based on the user's ID information and password information sent to the contents server;

sending the contents data for print-out to the printer, in a case where authentication is successful; and

printing out the contents represented by the content data for print-out sent to the printer.

A printing charge imposing method according to a sixth aspect of the present invention is for imposing a printing charge required for printing a contents utilizing a printing system which comprises a portable terminal; a contents server which stores contents data for browsing and contents data for print-out both representing a contents; and a printer having a charge collecting device for obtaining money inserted thereto, and a function for displaying data, the method comprising the steps of:

pre-storing printing charge determination data which represents a printing charge per sheet;

when the portable terminal, which has been supplied with the contents data for browsing from the contents server, sends print request information for requesting print-out of the contents data for print-out in accordance with a user's operation, acquiring the content data for print-out from the contents server in accordance with the print request information;

printing out the contents represented by the contents data for print-out;

determining the printing charge based on the printing charge determination data;

displaying the determined printing charge on the printer; and

obtaining money corresponding to the printing charge displayed on the printer, when such money is inserted to the charge collecting device.

A printing charge imposing method according to a seventh aspect of the present invention is for imposing a printing charge required for printing a contents utilizing a printing system which comprises a portable terminal; a contents server which stores contents data for browsing and contents data for print-out both representing a contents; and a printer, the method comprising the steps of:

pre-storing printing charge determination data which represents a printing charge per sheet;

when the portable terminal, which has been supplied with the contents data for browsing from the contents server, sends print request information for requesting print-out of the contents data for print-out in accordance with a user's operation, acquiring the content data for print-out from the contents server in accordance with the print request information;

printing out the contents represented by the contents data for print-out;

determining the printing charge based on the printing charge determination data; and

imposing the determined printing charge together with a communication charge on the user of the portable terminal.

The method according to the seventh aspect may comprise the steps of:

sending data representing the determined printing charge to the portable terminal; and

imposing the printing charge represented by the data sent to the portable terminal together with the communication charge on the user of the portable terminal.

In this case, the data representing the determined printing charge may be sent to the portable terminal via the printer.

The method according to the seventh aspect may comprise the steps of:

sending data representing the determined printing charge to the printer; and

imposing the printing charge represented by the data sent to the printer together with a communication charge on the user of the portable terminal.

The method according to the seventh aspect may comprise the steps of:

sending authentication information given to the user to the contents server;

authenticating the user based on the authentication information; and

supplying the contents data for browsing to the portable terminal, or the contents data for print-out to the printer, when authentication is successful.

A printing system according to an eighth aspect of the present invention comprises: a portable terminal; a contents server which stores contents data for browsing and contents data for print-out both representing a contents; and a printer, wherein:

the printer has a printing function for printing out the contents represented by the contents data for print-out, when acquiring the contents data for print-out from the contents server in accordance with print request information which the printer receives and is for requesting print-out of the contents data for print-out;

the portable terminal sends the print request information to the printer in accordance with a user's operation, in a case where the contents server supplies the contents data for browsing to the portable terminal;

the contents server supplies the contents data for browsing to the portable terminal; and

the printer or the contents server stores printing charge determination data which represents a printing charge per sheet, and determines a printing charge based on the printing charge determination data.

In the printing system:

the printer may store the printing charge determination data which represents a printing charge per sheet, and may determine the printing charge based on the printing charge determination data; and

the printer may comprise a display device for displaying the determined printing charge, and a charge collecting device for obtaining money corresponding to the displayed printing charge, when such money is inserted thereto.

In the printing system, the printer may store the printing charge determination data, may determine the printing charge based on the printing charge determination data, and may send data representing the determined printing charge to the portable terminal.

In this case, the portable terminal may receive the data representing the printing charge sent from the printer, and may send it to the outside.

In the printing system, the contents server may store the printing charge determination data, may determine the printing charge based on the printing charge determination data, and may send data representing the determined printing charge to the printer.

In this case, the printer may receive the data representing the printing charge sent form the contents server, and may send it to the outside.

In the printing system, in a case where the contents server stores the printing charge determination data, determines the printing charge based on the printing charge determination data, and sends data representing the determined printing charge to the printer:

the printer may receive the data representing the printing charge sent from the contents server, and may send it to the portable terminal; and

the portable terminal may receive the data representing the printing charge sent from the printer, and may send it to the outside.

In the printing system, the portable terminal may send authentication information given to the user to the contents server.

In this case, the contents server may authenticate the user based on the authentication information, and may supply the contents data for browsing to the portable terminal, in a case where authentication is successful.

In the printing system, the printer may send authentication information given to the user to the contents server.

In this case, the contents server may authenticate the user based on the authentication information, and may supply the contents data for print-out to the printer, in a case where authentication is successful.

A contents server according to a ninth aspect of the present invention comprises:

a memory which stores printing charge determination data representing a printing charge per sheet imposed on a user of a portable terminal for printing out a contents, and contents data for browsing and contents data for print-out both representing a contents;

a first control circuit which supplies the contents data for browsing to the portable terminal; and

a second control circuit which supplies the contents data for print-out to a printer in accordance with information sent from the printer for requesting supply of the contents data for print-out, and determines a printing charge required for printing out the contents represented by the contents data for print-out based on the printing charge determination data.

The contents server may further comprise a third control circuit which generates data representing the determined printing charge, and sends the generated data to the printer.

A printer according to a tenth aspect of the present invention comprises:

a first control circuit which acquires contents data for print-out representing a contents from an external contents server which stores the contents data for print-out, when supplied with print request information for requesting print-out of the contents data for print-out;

a printer head which prints out the contents represented by the contents data for print-out acquired by the first control circuit;

a memory which stores printing charge determination data which represents a printing charge per sheet; and

a second control circuit which determines a printing charge based on the printing charge determination data stored in the memory.

The printer may further comprise:

a display device which displays the determined printing charge; and

a charge collecting device which obtains money corresponding to the printing charge displayed on the display device, when such money is inserted thereto.

A computer data signal embedded in a carrier wave according to an eleventh aspect of the present invention represents a program for controlling a computer to function as:

a memory which stores printing charge determination data representing a printing charge per sheet required for printing out a contents, and contents data for browsing and contents data for print-out both representing a contents;

a first control circuit which supplies the contents data for browsing to a portable terminal; and

a second control circuit which supplies the contents data for print-out to a printer in accordance with information sent from the printer for requesting supply of the contents data for print-out, and determines a printing charge required for printing out the contents represented by the contents data for print-out based on the printing charge determination data.

A computer data signal embedded in a carrier wave according to a twelfth aspect of the present invention represents a program for controlling a computer having a printer head for printing out data to function as:

a first control circuit which acquires contents data for print-out representing a contents from an external contents server which stores the contents data for print-out, when supplied with print request information for requesting print-out of the contents data for print-out;

a printer head which prints out the contents represented by the contents data for print-out acquired by the first control circuit;

a memory which stores printing charge determination data which represents a printing charge per sheet; and

a second control circuit which determines a printing charge based on the printing charge determination data stored in the memory.

### BRIEF DESCRIPTION OF THE DRAWINGS

These objects and other objects and advantages of the present invention will become more apparent upon reading of the following detailed description and the accompanying drawings in which:

FIG. 1 is a flowchart for explaining one example of the outline of embodiments according to the present invention;

FIG. 2 is a flowchart for explaining another example of the outline of the embodiments according to the present invention;

FIG. 3 is a flowchart for explaining another example of the outline of the embodiments according to the present invention;

FIG. 4 is a flowchart for explaining another example of the outline of the embodiments according to the present invention;

FIG. 5 is a flowchart for explaining another example of the outline of the embodiments according to the present invention;

FIG. 6 is a flowchart for explaining another example of the outline of the embodiments according to the present invention;

FIG. 7 is a diagram for explaining an example of a structure of a printing system according to the embodiments of the present invention;

FIG. 8 is a diagram for explaining an example of a structure of a cellular phone;

FIG. 9 is a diagram for explaining an example of a structure of a MFP printer;

FIG. 10 is a diagram for explaining an example of a structure of a contents server;

FIG. 11 is a diagram for explaining an example of a structure of a contents provider;

FIG. 12 is a flowchart for explaining an example of a process performed by the printing system according to a first embodiment of the present invention;

FIG. 13 is a flowchart for explaining an example of a process performed by the printing system according to a second embodiment of the present invention;

FIG. 14 is a flowchart for explaining an example of a process performed by the printing system according to a third embodiment of the present invention;

FIG. 15 is a flowchart for explaining an example of a process performed by the printing system according to a fourth embodiment of the present invention; and

FIG. 16 a flowchart for explaining an example of a process performed by the printing system according to a fifth embodiment of the present invention.

### DETAILED DESCRIPTION OF THE PREFERRED EMBODIMENTS

The embodiments of the present invention will now be explained below with reference to the drawings.

### The Outline of the Embodiments

The outline of the embodiments will be explained first.

A printer used in the printing system of the present invention comprises a function for displaying an image, and a charge collecting device for acquiring money inserted thereto. The printer also comprises printing charge determination data for determining a charge required for printing. The printing charge determination data represents printing charge required for each sheet based on the printing type (color or monochrome).

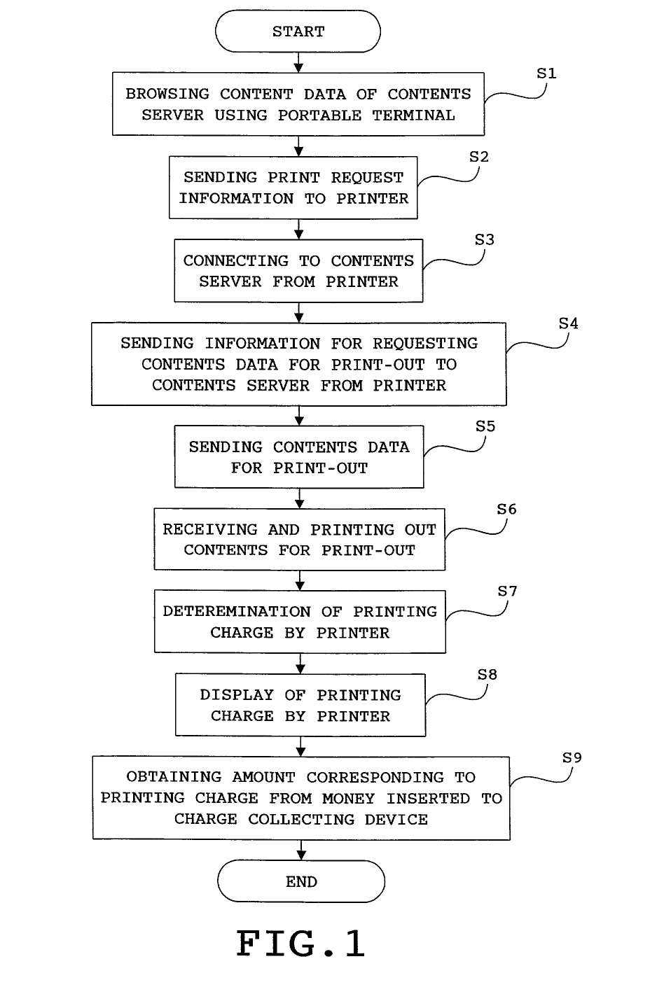

In one embodiment, imposition of the printing charge is executed by the procedure shown in FIG. 1. First, a user browses contents data loaded in a contents server using a portable terminal (step S1). Then, the user sends print request information for requesting print-out of the content data to the printer from the portable terminal (step S2). The printer connects to the contents server in accordance with the print request information (step S3). The printer sends information for requesting corresponding contents data for print-out to the contents server (step S4). The contents server sends the contents data for print-out to the printer (step S5). When receiving the contents data for print-out from the contents server, the printer prints out the received contents data for print-out (step S6). The printer determines the printing charge based on the printing charge determination data in accordance with the executed print-out of the contents data for print-out (step S7). Then, the printer displays the determined printing charge on a display unit (step S8). When money corresponding to the displayed printing charge is inserted into the charge collecting device, the printer acquires the money (step S9).

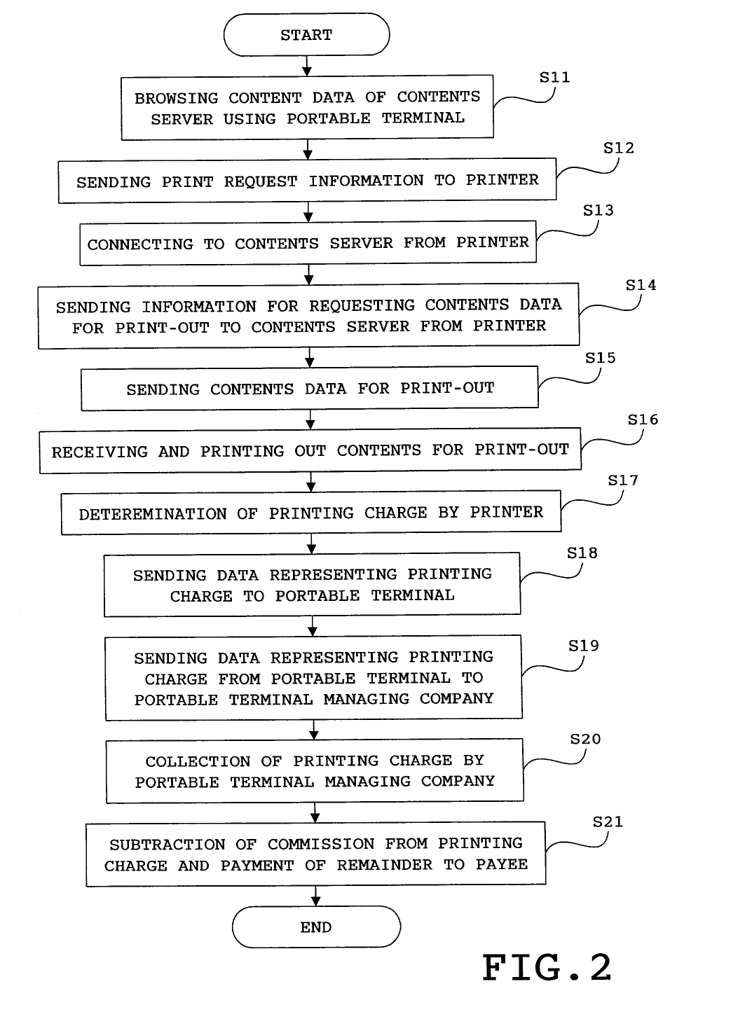

In another embodiment, imposition of the printing charge is executed by the procedure shown in FIG. 2. A user browses contents data loaded in the contents server using a portable terminal (step S11). Then, the user sends print request information for requesting print-out of the contents data to the printer from the portable terminal (step S12). The printer connects to the contents server in accordance with the print request information (step S13). The printer sends information for requesting corresponding contents data for print-out to the contents server (step S14). The contents server sends the contents data for print-out to the printer (step S15). When receiving the contents data for print-out from the contents server, the printer prints out the received contents data for print-out (step S16). The printer determines the printing charge based on the printing charge determination data in accordance with the executed print-out of the contents data for print-out (step S17). The printer sends data representing the determined printing charge to the portable terminal (step S 18). The portable terminal stores the data sent from the printer, and sends the data to the company managing the portable terminal at a predetermined timing (step S19). The managing company imposes the printing charge represented by the data together with the communication charge on the user of the portable terminal (step S20). An amount derived by subtracting a predetermined commission from the printing charge is paid to a predetermined payee (step S21).

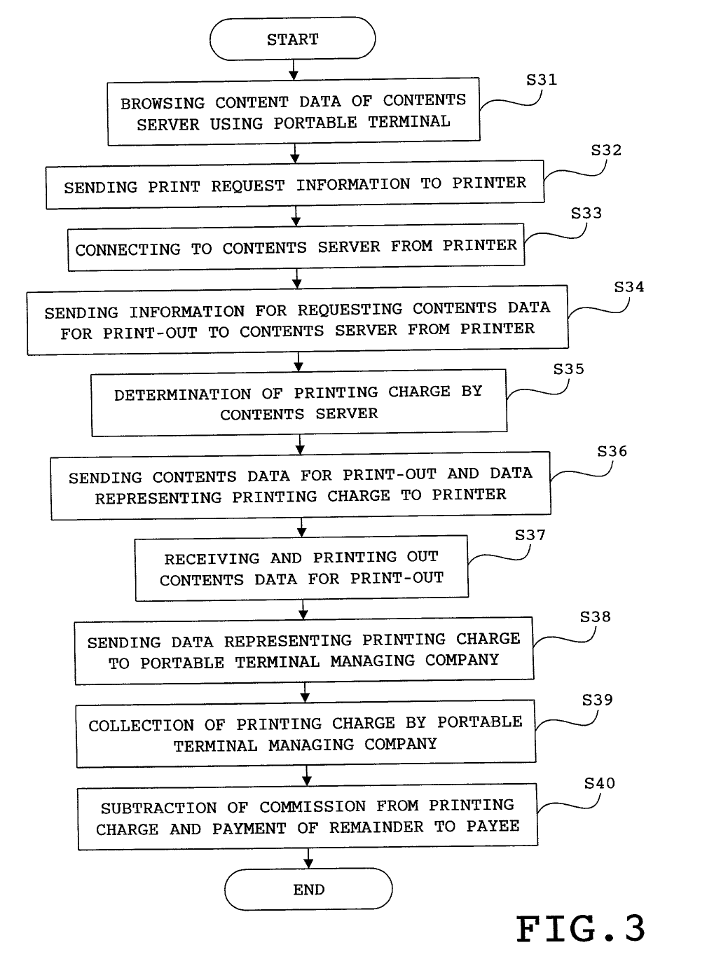

In another embodiment, the printing charge determination data is stored in the contents server. In this case, imposition of the printing charge is executed by the procedure shown in FIG. 3.

A user browses contents data loaded in the contents server using a portable terminal (step S3 1). The user sends print request information for requesting print-out of the contents data to the printer from the potable terminal (step S32). The printer connects to the contents server in accordance with the print request information (step S33). The printer sends information for requesting corresponding contents data for print-out to the contents server (step S34). In accordance with the information for requesting the contents data for print-out, the contents server determines the printing charge based on the printing charge determination data (step S35). The contents server sends data representing the determined printing charge together with the contents data for print-out to the printer (step S36). The printer prints out the contents data for print-out sent from the contents server (step S37). The printer sends the data representing the printing charge to the company managing the portable terminal (step S38). The managing company imposes the printing charge represented by the data together with the communication charge on the user of the portable terminal (step S39). An amount derived by subtracting a predetermined commission from the printing charge is paid to a predetermined payee (step S40).

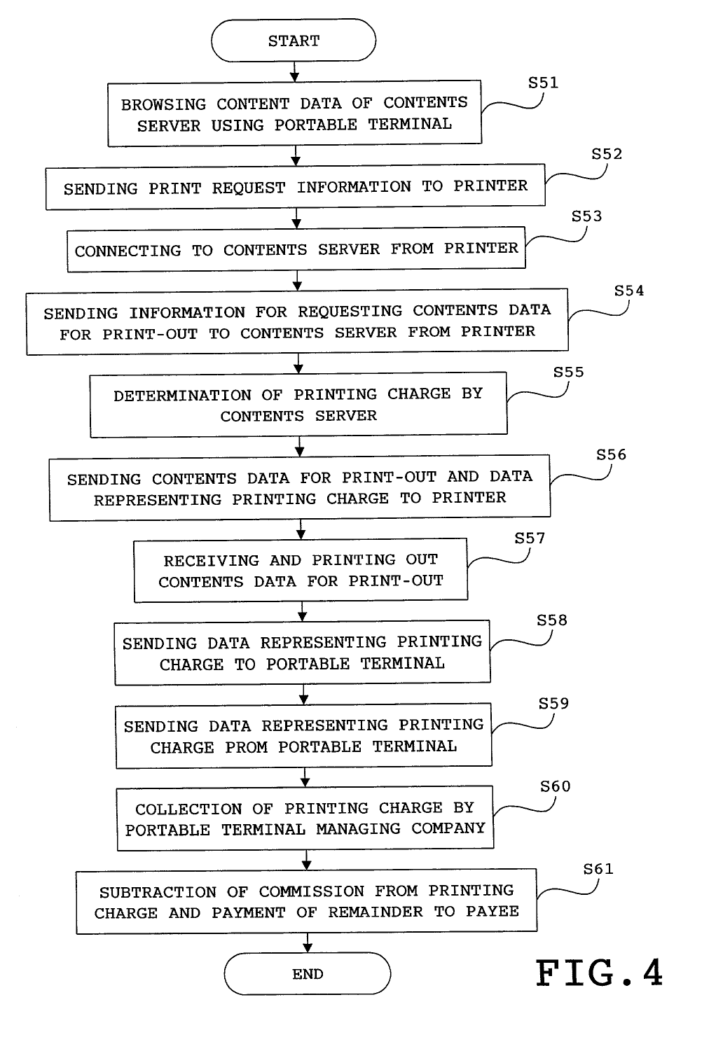

In another embodiment, imposition of the printing charge is executed by the procedure shown in FIG. 4. A user browses contents data loaded in the contents server using a portable terminal (step S51). The user sends print request information for requesting print-out of the contents data to the printer from the portable terminal (step S52). The printer connects to the contents server in accordance with the print request information (step S53). The printer sends information for requesting corresponding contents data for print-out to the contents server (step S54). In accordance with the information for requesting the contents data for print-out, the contents server determines the printing charge based on the printing charge determination data (step S55). The contents server sends data representing the determined printing charge together with the contents data for print-out to the printer (step S56). The printer prints out the contents data for print-out sent from the contents server (step S57). The printer sends the data representing the printing charge to the portable terminal (step S58). The portable terminal stores the data sent from the printer, and sends the data to the company managing the portable terminal at a predetermined timing (step S59). The managing company imposes the printing charge represented by the data together with the communication charge on the user of the portable terminal (step S60). An amount derived by subtracting a predetermined commission from the printing charge is paid to a predetermined payee (step S61).

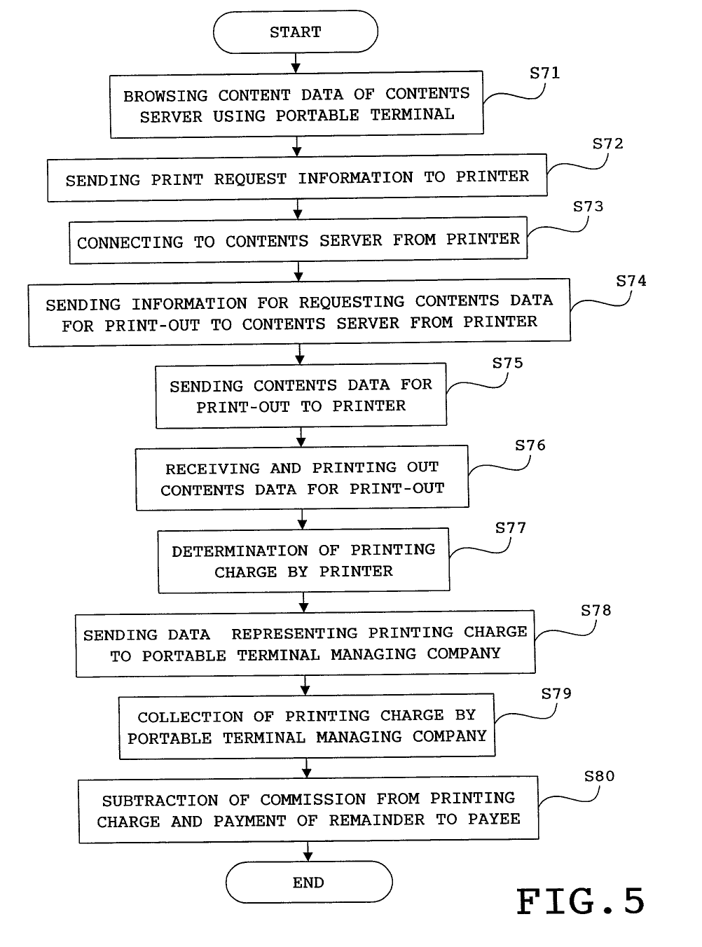

In another embodiment, the printing charge determination data is stored in the printer. In this case, imposition of the printing charge is executed by the procedure shown in FIG. 5.

A user browses contents data loaded in the contents server using a portable terminal (step S71). The user sends print request information for requesting print-out of the contents data to the printer from the portable terminal (step S72). The printer connects to the contents server in accordance with the print request information (step S73). The printer sends information for requesting corresponding contents data for print-out to the contents server (step S74). The contents server sends the contents data for print-out to the printer (step S75). The printer prints out the contents data for print-out sent from the contents server (step S76). The printer determines the printing charge based on the printing charge determination data in accordance with the executed print-out of the contents data for print-out (step S77). The printer sends data representing the determined printing charge to the company managing the portable terminal (step S78). The managing company imposes the printing charge represented by the data together with the communication charge on the user of the portable terminal (step S79). An amount derived by subtracting a predetermined commission from the printing charge is paid to a predetermined payee (step S80).

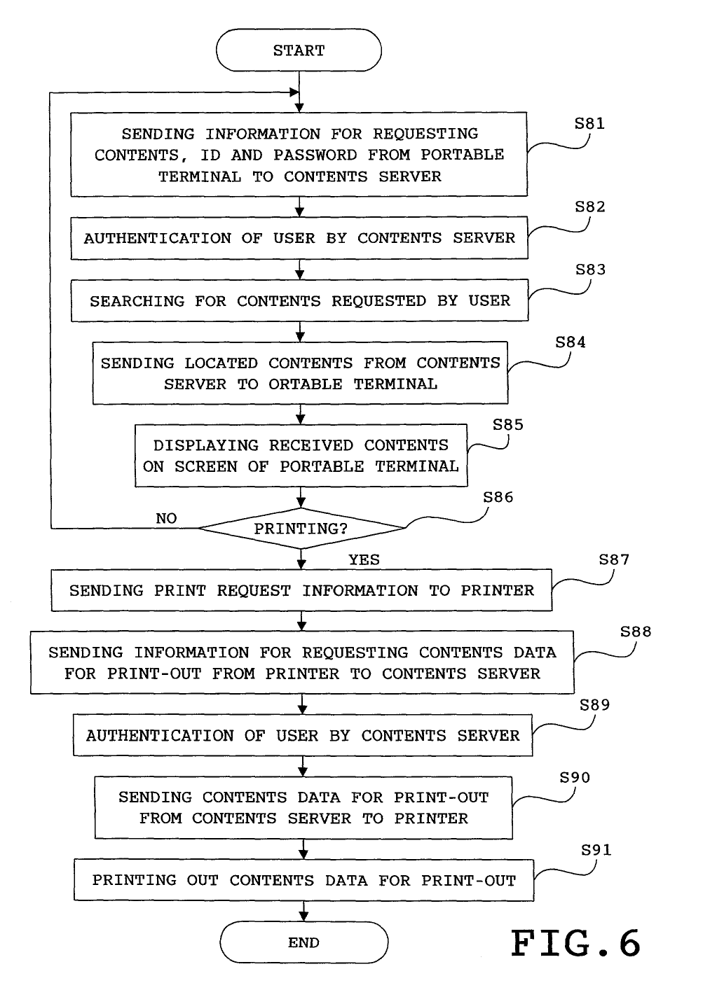

In each of the above-described embodiments, user authentication may be executed by the procedure shown in FIG. 6. That is, a portable terminal sends data including the user's ID (IDentification) and password to the contents server (step S81). The contents server executes user authentication based on the ID and password (step S82). In a case where authentication is successful, the contents server searches out contents data for browsing representing the user's desired contents (step S83), and sends the contents data for browsing to the portable terminal (step S84). The portable terminal displays the contents represented by the contents data for browsing sent from the contents server (step S85). The user determines whether or not to print out the displayed contents (step S86). In a case where the user determines to print out the contents, the portable terminal sends print request information including the URL (Uniform Resource Locator) of corresponding contents data for print-out which represents the contents to the printer in accordance with the user's operation (step S87). In accordance with the print request information, the printer sends information for requesting supply of the user's desired contents data, and user's ID and password to the contents server (step S88). The contents server executes user authentication again (step S89). In a case where authentication is successful, the contents server searches out the contents data for print-out, and sends it to the printer (step S90). The printer prints out the contents represented by the contents data for print-out sent from the contents server (step S91).

First Embodiment

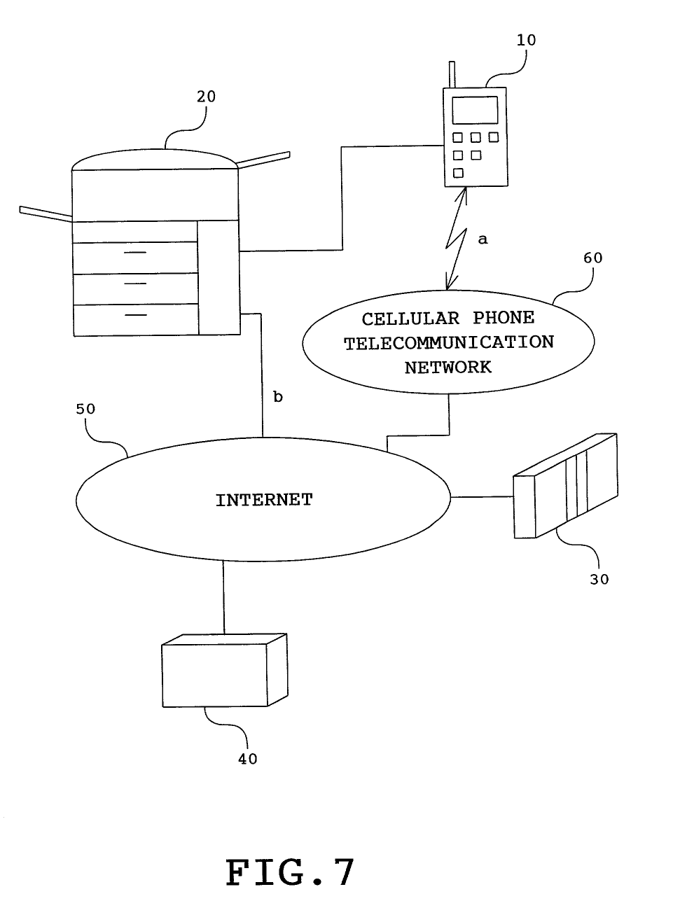

FIG. 7 is a diagram for explaining the structure of the printing system according to this embodiment of the present invention.

In FIG. 7, a numeral 10 denotes a cellular phone, a numeral 20 denotes a MFP (Multi Function Peripheral) printer (printing apparatus), a numeral 30 denotes a contents server (or a gateway server), a numeral 40 denotes a contents provider, a numeral 50 denotes the Internet, and a numeral 60 denotes a cellular phone telecommunication network.

The cellular phone 10 functions as a terminal such as a portable phone, a PHS (Personal Handyphone System), or a GSM (Global System for Mobile communication). The cellular phone 10 comprises a portable structure, and is connected to the cellular phone telecommunication network 60. The cellular phone 10 has its own phone number.

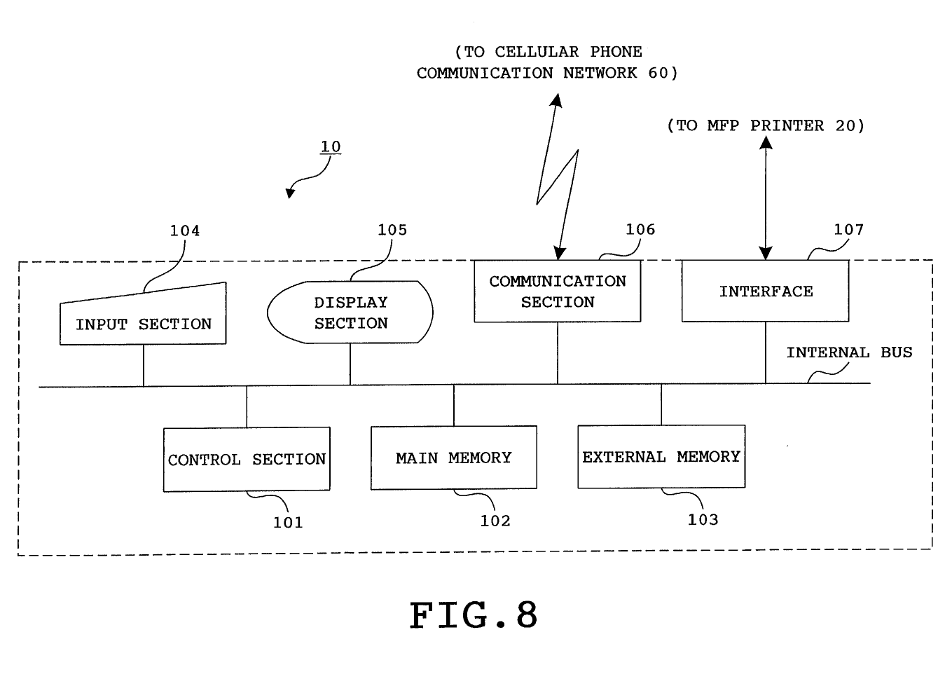

As shown in FIG. 8, the cellular phone 10 comprises a control section 101, a main memory 102, an external memory 103, an input section 104, a display section 105, communication section 106, and an interface 107. The main memory 102, the external memory 103, the input section 104, the display section 105, the communication section 106, and the interface 107 are connected to the control section 101 via an internal bus.

The control section 101 comprises a CPU (Central Processing Unit). The control section 101 executes an operation described later in accordance with a program stored in the external memory 103.

The main memory 102 comprises a volatile storage such as a RAM (Random Access Memory) or the like. The storage area of the main memory 102 is used as the work area of the control section 101.

The external memory 103 comprises a nonvolatile storage such as an EEPROM (Electrically Erasable/Programmable Read Only Memory) or the like. The external memory 103 pre-stores a program, and an ID and a password which are given to a user of the cellular phone 10. The program stored in the external memory 103 is for controlling the control section 101 to execute an operation described later. The external memory 103 supplies the program, and the ID and password stored therein to the control section 101 in accordance with an instruction given by the control section 101.

The input section 104 comprises a button switch or the like. The input section 104 supplies information following an operation of an operator to the control section 101.

The display section 105 comprises an LCD (Liquid Crystal Display) or the like. The display section 105 displays an image following an instruction given by the control section 101 on a display screen thereof.

The communication section 106 comprises a radio transmitter, a radio receiver, or the like. The communication section 106 transmits information supplied from the control section 101 to the cellular phone telecommunication network 60 by radio in accordance with an instruction given by the control section 101. The communication section 106 receives information addressed to the cellular phone 10 from the cellular phone telecommunication network 60 and supplies the received information to the control section 101.

The cellular phone telecommunication network 60 comprises a packet network connected to the Internet 50. The packet network provides, for example, an i-mode™ service of NTT DoCoMo Inc.

The packet network performs a DNS (Domain Name Service) operation when receiving information including a URL (Uniform Resource Locator) from the communication section 106 of the cellular phone 10. Specifically, the packet network specifies a server represented by this URL, and sends the information which it receives from the cellular phone 10 to this server via the Internet 50. And when receiving information including the URL of the cellular phone 10 via the Internet 50, the packet network sends the information to the cellular phone 10.

The interface 107 comprises, for example, an USB (Universal Serial Bus) interface. The interface 107 is so structured as to be attachable to a portable terminal interface 205 (described later) of the MFP printer 20.

Let it be assumed that the interface 107 is connected to the portable terminal interface 205. In this case, the interface 107 sends information supplied from the control section 101 to the MFP printer in accordance with an instruction given by the control section 101. And the interface 107 receives information sent from the MFP printer 20, and supplies the information to the control section 101.

The MFP printer 20 and the cellular phone 10 may be connected with each other by using cables, or by radio. In case of by radio, the interface 107 and the portable terminal interface 205 may, for example, comprise short-range radio-communication devices based on the Bluetooth standards. However, the communication method is not limited to this example.

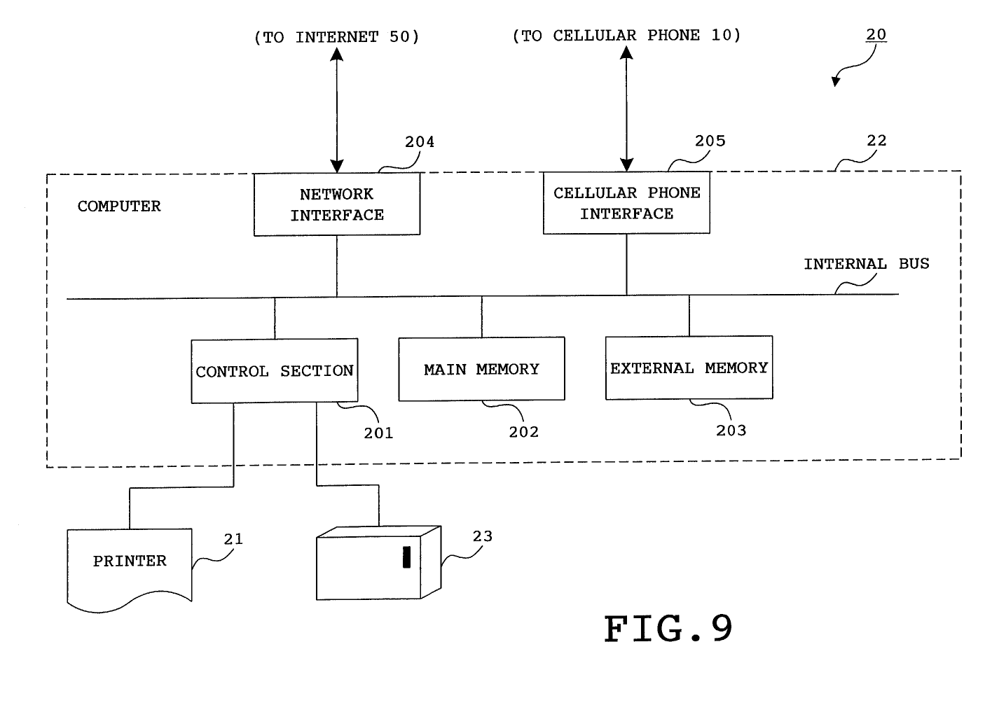

As shown in FIG. 9, the MFP printer (printing apparatus) 20 comprises a printer 21, a computer 22, and a coin box 23. The printer 21 and the coin box 23 are respectively connected to the computer 22.

The printer 21 prints out data under the control of the computer 22.

The computer 22 comprises, for example, a control section 201, a main memory 202, an external memory 203, a network interface 204, a portable terminal interface 205, and a display section 206. The main memory 202, the external memory 203, the network interface 204, the portable terminal interface 205, and the display section 206 are connected to the control section 201 via an internal bus. The printer 21 is connected to the control section 201.

The control section 201 comprises a CPU and a printer interface circuit. The control section 201 performs operations described later such as controlling the printer 21 to print data, in accordance with a program stored in the external memory 203.

The main memory 202 comprises a volatile storage such as a RAM or the like. The storage area of the main memory 202 is used as the work area of the control section 201.

The external memory 203 comprises a nonvolatile storage such as a hard disk device or the like. The external memory 203 stores a program for controlling the control section 201 to execute an operation described later, and the printing charge determination data.

The external memory 203 supplies data stored therein to the control section 201 in accordance with an instruction given by the control section 201. The printing charge determination data includes, for example, data representing the printing charge for color printing, and the printing charge for monochrome printing which are described later. The printing charge may be determined by the size or kind of a sheet of paper to be used in printing.

The network interface 204 comprises, for example, a DSU (Data Service Unit). The network interface 204 is connected to the Internet 50.

The network interface 204 sends information supplied from the control section 201 to the contents server 30 via the Internet 50 in accordance with an instruction given by the control section 201.

The network interface 204 receives information addressed to the MFP printer 20 from the Internet 50, and supplies the information to the control section 201. In a case where the information addressed to the MFP printer 20 is a program, the MFP printer 20 loads this program. That is, the network interface 204 supplies this program to the control section 201, and the control section 201 stores this program in the external memory 203. By execution of this loaded program by the control section 201, the MFP printer 20 performs an operation described later.

The MFP printer 20 and the Internet 50 may be connected with each other by using cables, or by radio. In case of by radio, the network interface 204 may, for example, comprise a wireless LAN (Local Area Network). However, the connection method is not limited to this example.

Instead of loading a program via a network, the MFP printer 20 may load the program by reading the program from a recording medium such as a CD-ROM, a flexible disk, or the like. However, in this case, the MFP printer 20 should comprise a recording medium driver for reading data from the recording medium, instead of the network interface 204.

The portable terminal interface 205 comprises, for example, a USB interface. The portable terminal interface 205 is so structured as to be attachable to the interface 107 of the cellular phone 10.

Let it be assumed that the portable terminal interface 205 is connected to the interface 107. In this case, the portable terminal interface 205 sends information supplied from the control section 201 to the cellular phone 10 in accordance with an instruction given by the control section 201. And the portable terminal interface 205 receives information sent from the cellular phone 10, and supplies the information to the control section 201.

The display section 206 comprises a LCD or the like. The display section 206 displays an image following an instruction given by the control section 201 on a display screen thereof.

The coin box 23 may comprise the same structure as that of a box which is attached to a charge-requiring copying machine which provides the copying service when a coin is inserted into the box. That is, this box may comprise an interface for detecting that the MFP printer 20 has printed out some contents, a slot into which a coin is inserted, a device for collecting an amount corresponding to the printing charge from the coin which has been inserted, and a device for returning an amount that has not been collected in accordance with a user's operation.

The printing function provider who provides the printing function of this printing system installs software for controlling the MFP printer 20 to realize the printing function in the MFP printer 20. The software is capable of controlling the MFP printers 20 to execute targeted actions regardless of the manufacturers and models of the MFP printers 20. The MFP printers 20 in which the software is installed are to be placed in convenience stores, DPE service providing shops and the like. That is, the MFP printers 20 may be put in any places that may be convenient for users.

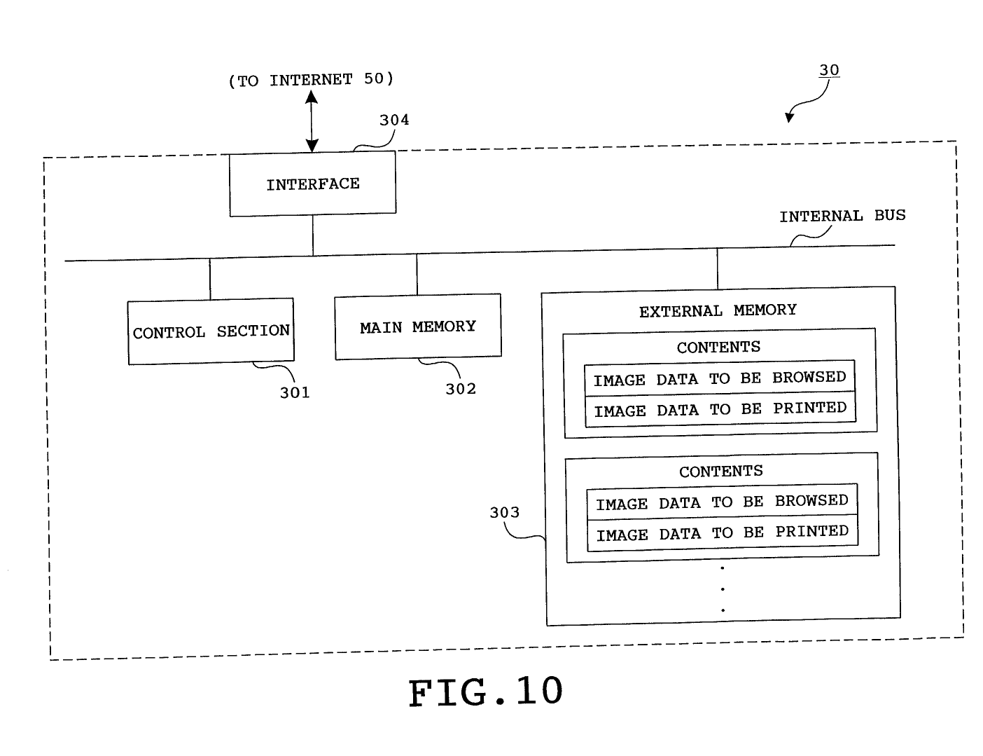

The contents server 30 comprises a server computer. Specifically, the contents server 30 comprises, for example, a structure shown in FIG. 10. That is, the contents server 30 comprises, for example, a control section 301, a main memory 302, an external memory 303, and an interface 304.

The main memory 302, the external memory 303, and the interface 304 are connected to the control section 301 via an internal bus.

The control section 301 comprises a CPU. The control section 301 executes an operation described later in accordance with a program stored in the external memory 303.

The main memory 302 comprises a volatile storage such as a RAM or the like. The storage area of the main memory 302 is used as the work area of the control section 301.

The external memory 303 comprises a nonvolatile storage such as a hard disk device or the like. The external memory 303 stores a program and contents. The program is for controlling the control section 301 to execute an operation described later. The contents include image data. The external memory 303 supplies data stored therein to the control section 301 in accordance with an instruction given by the control section 301.

Each of the contents stored in the external memory 303 includes image data to be browsed using an i-mode™ cellular phone, and image data to be printed out by the MFP printer 20, as shown in FIG. 10. A URL is given to each of the image data to be browsed using an i-mode™ cellular phone, and the image data to be printed out by the MFP printer 20. However, those two kinds of image data may be the same. In this case, the single image data may have either one URL or two URLs.

The interface 304 comprises a communication control device such as a DSU. The interface 304 is connected to the Internet 50.

The interface 304 sends information supplied from the control section 301 to the cellular phone 10 via the Internet 50 and the packet network in accordance with an instruction given by the control section 301. The interface 304 receives information addressed to the contents server 30 from the Internet 50, and supplies the information to the control section 301.

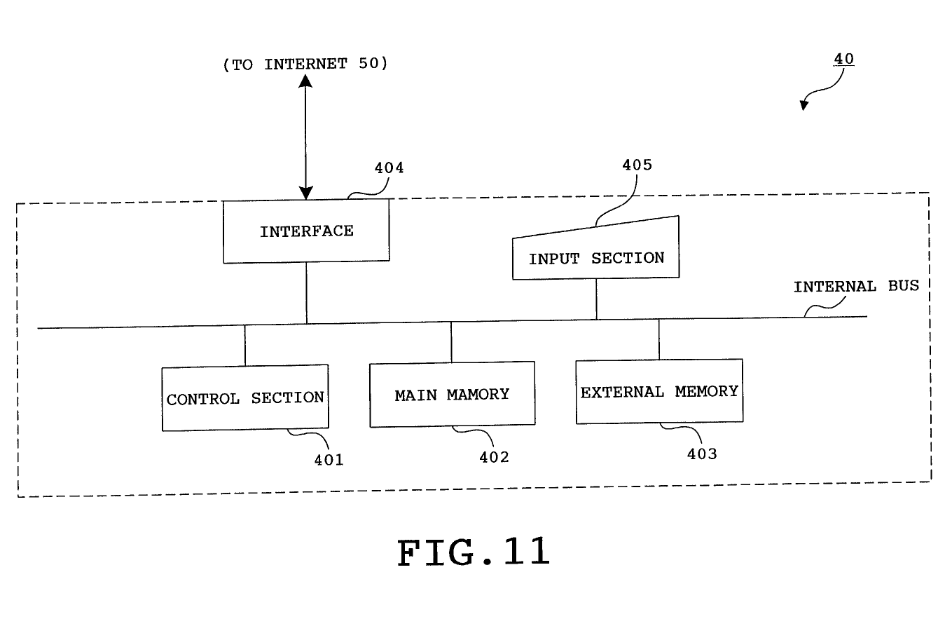

The contents provider 40 comprises a server computer. Specifically, the contents provider 40 comprises, for example, a structure shown in FIG. 11. That is, the contents provider 40 comprises, for example, a control section 401, a main memory 402, an external memory 403, an interface 404, and an input section 405.

The main memory 402, the external memory 403, the interface 404, and the input section 405 are connected to the control section 401 via an internal bus.

The control section 401 comprises a CPU. The control section 401 executes an operation described later in accordance with a program stored in the external memory 403. The control section 401 may further execute an operation for producing contents in accordance with a program stored in the external memory 403. The program for controlling the operation for producing contents is, for example, a graphical application.

The main memory 402 comprises a volatile storage such as a RAM or the like. The storage area of the main memory 402 is used as the work area of the control section 401.

The external memory 403 comprises a nonvolatile storage such as a hard disk device or the like. The external memory 403 stores a program for controlling the control section 401 to execute an operation described later, and contents to be supplied to the contents server 30. The external memory 403 supplies data stored therein to the control section 401 in accordance with an instruction given by the control section 401.

The interface 404 comprises a communication control device such as a DSU. The interface 404 is connected to the Internet 50.

The interface 404 sends information supplied from the control section 401 to the contents server 30 via the Internet 50 in accordance with an instruction given by the control section 401.

The input section 405 comprises a keyboard, a mouse, a tablet, and the like. The input section 405 supplies information following an operation of an operator to the control section 401. The input section 405 may comprise a recording medium driver for reading data such as image data from a recording medium.

When starting a business utilizing this printing system, the printing function provider installs software in the MFP printer 20. The printing function provider collects the charge (printing charge) required to use this printing system. For example, a user may pay a predetermined monthly charge to the printing function provider. The printing function provider may give permission to use this printing system to a user who pays this monthly charge.

The monthly charge (basic charge) required for utilizing this printing system is set at, for example, 1 dollar per month. Users are further required to pay a predetermined printing charge each time they print out data using this printing system. The printing charge is collected in a shop in which the MFP printer 20 is installed by means of the coin box 23. The printing charge is set at, for example, 30 cents per sheet for monochrome printing, and 1 dollar per sheet for color printing. The basic charges are collected from users by the company managing the cellular phone 10 (cellular phone company) on behalf of the printing function provider. The cellular phone company subtracts predetermined commissions from the collected basic charges, and pays the remainder to the printing function provider. If the printing function provider entrusts the management of their server or the like to a third party, the provider pays to the third party, a predetermined amount from the remainder which the provider receives.

Next, the operation of the printing system will be explained.

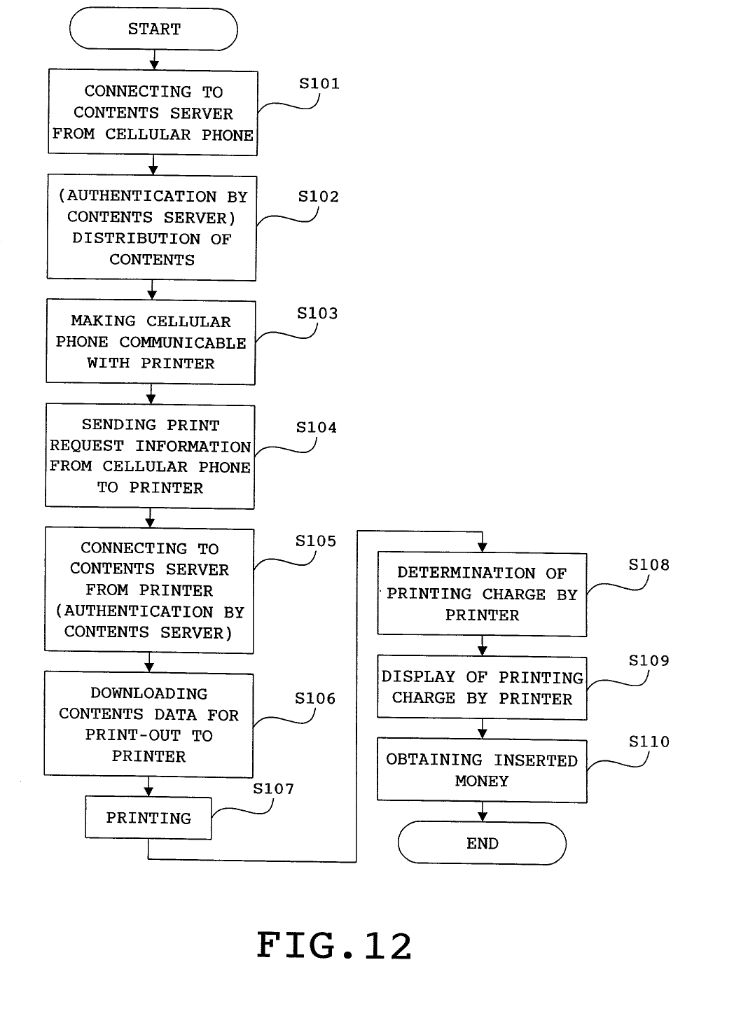

FIG. 12 is a flowchart for explaining a process executed by this printing system.

As shown in FIG. 6, the cellular phone 10 is connected to the contents server 30 in accordance with an operation of a user (step S101). This connection is performed via the cellular phone telecommunication network 60 and the Internet 50. The user browses the contents stored in the contents server 30 using the cellular phone 10.

The cellular phone 10 has a function for browsing contents data stored in the contents server 30 and downloading the contents data. This function is realized by, for example, the aforementioned cellular phone corresponding to the i-mode™ service. In the i-mode™ service, the contents to be distributed by the contents server 30 is loaded in an official site authenticated by NTT DoCoMo Inc. Contents data stored in the contents server 30 is produced by, for example, the contents provider 40. The produced contents data is transferred to the contents server 30 after authenticated by NTT DoCoMo Inc.

If an official site is a charge-requiring site, users are required to subscribe to the official site in advance, in order to access this official site using the cellular phone 10 and browse the contents. When users subscribe to an official site, an information charge is set for them. Information charges may be freely set by contents providers providing official sites. A typical information charge is several dollars per month. In a case where the cellular phone 10 accesses an official charge-requiring site using the i-mode™ function, the contents server 30 authenticates the cellular phone 10 with regard to data downloading. That is, before the cellular phone 10 downloads data from a charge-requiring official site, the contents server 30 authenticates an ID and a password sent from the cellular phone 10.

Upon accessing the contents server 30, the cellular phone 10 calls a site including the user's desired contents that is provided for cellular phones. Then, the cellular phone 10 sends the user's ID and password to be authenticated. After performing authentication, the contents server 30 searches for the contents requested by the cellular phone 10, and distributes the contents to the cellular phone 10 (step S102). In step S102, the contents is distributed via the cellular phone telecommunication network 60 of the cellular phone company and via a route “a” shown in FIG. 7.

Upon receiving the contents, the cellular phone 10 displays the contents on the display screen thereof. The user browses the contents while looking at the display screen. If the user finds something on the display that he/she wants to print out, the user gets the cellular phone 10 in an interface where the cellular phone 10 can communicate with the MFP printer 20 (step S103). Specifically, for example, the user brings the cellular phone 10 to a place where the MFP printer 20 is installed (for example, a convenience store), and connects the cellular phone 10 to the MFP printer 20. In a case where the cellular phone 10 and the MFP printer 20 can communicate with each other by radio, the user moves to an area where the MFP printer 20 and the cellular phone 10 can communicate. Then, the user performs a predetermined operation to the input section 104 of the cellular phone 10 in order to send print request information, and the user's ID and password from the cellular phone 10 to the MFP printer 20 (step S104). The print request information may include the user's ID and password.

Data included in the contents that can be browsed by i-mode™ cellular phones may be the same as data included in the contents that can be browsed by WWW terminals. However, i-mode™ cellular phones have many limitations with regard to displaying their contents. For example, some i-mode™ cellular phones may have a lower capacity limit than that of WWW termninals for accepting contents. Some i-mode™ cellular phones may not be capable of color display. i-mode™ cellular phones have smaller screens than those of WWW terminals. Therefore, it is preferable that the contents provider 40 separately produces data for i-mode™ contents and data for WWW contents.

The print request information includes URL (Uniform Resource Locator) information. The URL information specifies the contents that the user has located and wants to print out. The print request information also includes information for designating the printing type (for example, color printing or monochrome printing) and the number of copies to be printed.

Upon reception of the print request information, the MFP printer 20 connects to the Internet 50, and accesses the contents included in a site specified by the URL information, among the contents stored in the contents server 30 (step S105). This site is the one that includes the desired contents of the user. After connecting to the contents server 30, the MFP printer 20 sends the user's ID and password to the contents server 30, just like the cellular phone 10 sends the user's ID and password in step S102. The contents server 30 performs authentication using the ID and password sent from the MFP printer 20 (step S105), like it does in step S102, and only in a case where authentication goes well, the contents server 30 permits the operation in step S106 to be performed.

When authentication is successful, the MFP printer 20 downloads contents data for the WWW (contents data for print-out) from this site (step S106). The contents data is downloaded through a route “b” shown in FIG. 7. Then, the downloaded contents data is printed out on a sheet which the user chooses (step S107). In a case the user intends to print out more than one contents, the user repeats selecting a contents and sending the print request information to the MFP printer 20, using the cellular phone 10.

The MFP printer 20 determines which of color printing and monochrome printing it has performed, and also determines what size of sheet(s) it printed on. Then, the MFP printer 20 determines the printing charge based on the determination results and the printing charge determination data stored therein (step S108).

The MFP printer 20 displays the determined printing charge on the display screen of the display section 206 (step S109). The printing charge may be displayed each time the MFP printer 20 prints out on a sheet, added to the printing charge accumulated so far. Or, when the user gives a predetermined instruction, the MFP printer 20 may display the total printing charge in accordance with the instruction.

The user puts enough money into the coin box 23, after printing is completed. The coin box 23 obtains an amount corresponding to the printing charge from the inserted money (step S110). If any amount is left unused, this box returns the unused amount to the user.

The conventional printers usually require money to be inserted before printing is performed, and after the printing, those printers require more money or return the extra. In contrast, since this printing system requires money to be inserted after printing is performed, the user can insert the exact amount required. Therefore, this printing system is more convenient for the user than the conventional printers.

The authentication steps may be performed or may not be performed (see last paragraph of the Outline of the Embodiments).

This printing system comprises the cellular phone (portable terminal) 10 having the i-mode™ function or the like, and capable of browsing contents, the MFP printer 20 connected to a network, and the contents server 30. The cellular phone 10, the MFP printer 20, and the contents server 30 are connected to a public line and/or a private line, and can communicate with one another. Software for realizing the functions of the printing system needs to be installed in the MFP printer 20. The contents provider 40 is required to have a system for distributing WWW contents data which is substantially the same as contents data for cellular phones. Contents data for cellular phones distributed by the contents provider 40 is produced so as to include a menu by which users can instruct this printing system to perform printing operation. Therefore, users can easily give an instruction to carry out printing using the cellular phone 10.

Second Embodiment

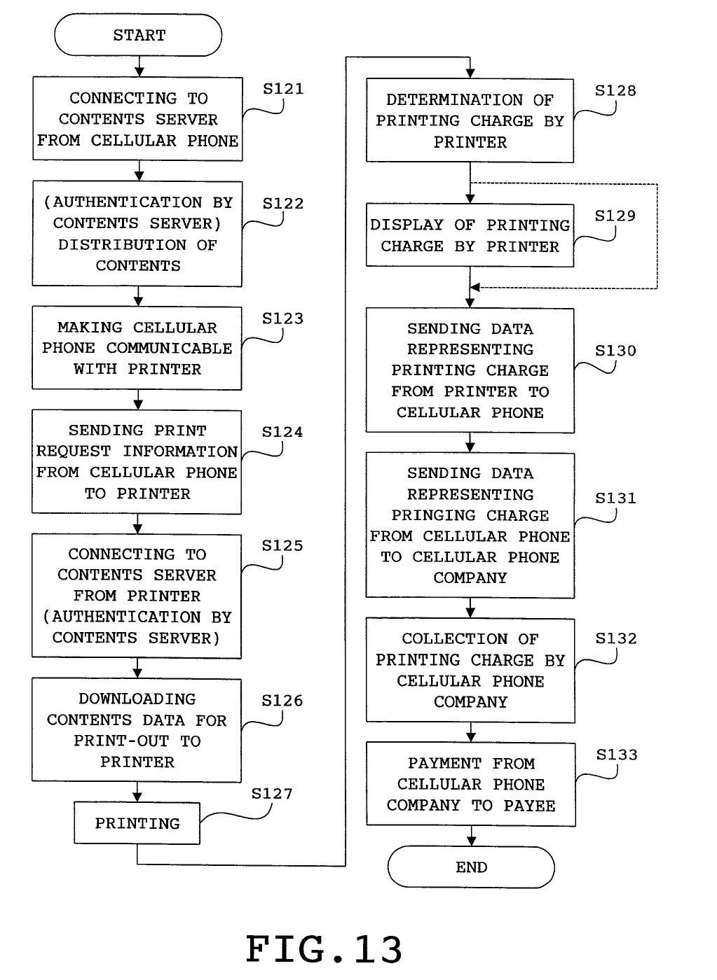

FIG. 13 is a flowchart for explaining the operation of the printing system according to the second embodiment of the present invention. The physical structure of the printing system according to this embodiment is substantially the same as that of the printing system according to the first embodiment.

In this printing system, the process steps from the beginning to the determination of the printing charge by the MFP printer 20 are performed by following the same steps as steps S101 to S108 of the first embodiment (steps S121 to S128).

Then, the MFP printer 20 displays the determined printing charge (step S129). However, this step may be omitted.

The MFP printer 20 sends data representing the printing charge to the cellular phone 10 each time it prints out on a sheet (step S130). Or, the MFP printer 20 may send such data to the cellular phone 10 after it finishes all printing. The cellular phone 10 stores the data which it receives from the MFP printer 20.

Then, the cellular phone 10 sends the data to the cellular phone company at a timing which meets a predetermined condition (step S131). Specifically, the data may be sent at a predetermined time, or immediately after the cellular phone 10 receives the data representing the printing charge.

The cellular phone company records the printing charge user by user. Later on, the cellular phone company collects the total charges including the printing charge and the basic charge on behalf of the printing function provider, together with the communication charge (step S132). The cellular phone company pays the amount obtained by subtracting a predetermined commission from the collected total charges to predetermined payees such as the printing function provider, and the shop installing the MFP printer 20 (step S133).

The cellular phone 10 may display the printing charge on the display section 105, when it receives the data representing the printing charge. In this case, since the cellular phone 10 informs the user of the printing charge, the user can enjoy more convenience with the use of this printing system.

Third Embodiment

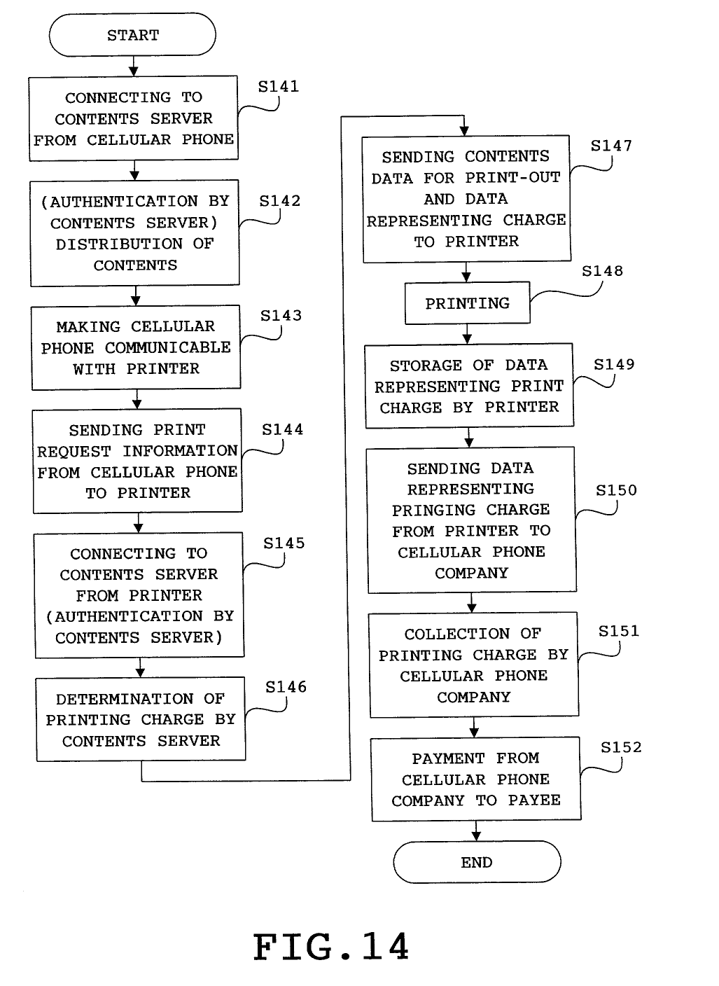

FIG. 14 is a flowchart for explaining the operation of the printing system according to the third embodiment of the present invention. The physical structure of the printing system according to this embodiment is substantially the same as that of the printing system according to the first embodiment. However, the printing charge determination data for determining the charge to be imposed on the user is stored in the contents server 30, not in the MFP printer 20.

In this printing system, the process steps from the beginning to the connection by the MFP printer 20 to the contents server 30 (and/or authentication by the contents server 30) are performed by following the same steps as steps S101 to S105 of the first embodiment (steps S141 to S145).

After connecting to the contents server 30, the MFP printer 20 sends to the contents server 30, the data for designating the printing type and the number of copies included in the print request information which the cellular phone 10 sends to the MFP printer 20. The contents server 30 determines the printing charge to be imposed on the user based on the printing type and number of copies represented by the data, and on the printing charge determination data stored in the contents server 30 (step S146). Then, the contents server 30 sends data representing the determined printing charge together with the contents data for print-out to the MFP printer 20 (step S147).

The MFP printer 20 receives and prints the contents data for print out (step S148). The MFP printer 20 stores the data representing the printing charge sent together with the contents data in the main memory 202 or in the external memory 203 in association with the ID and password of the user of the cellular phone 10 (step S149).

After printing is completed, the MFP printer 20 connects to the server (not shown) operated by the cellular phone company. This connection is performed, for example, via the Internet 50. The MFP printer 20 sends the data representing the printing charge, and the ID and password stored in association with each other to this server (step S150).

The cellular phone company collects the total charges including the basic charge and the printing charge represented by the data sent from the MFP printer 20 on behalf of the printing function provider, together with the communication charge (step S151). The cellular phone company pays the amount obtained by subtracting a predetermined commission from the collected total charges, to predetermined payees such as the printing function provider, the shop installing the MFP printer 20 (step S152).

Fourth Embodiment

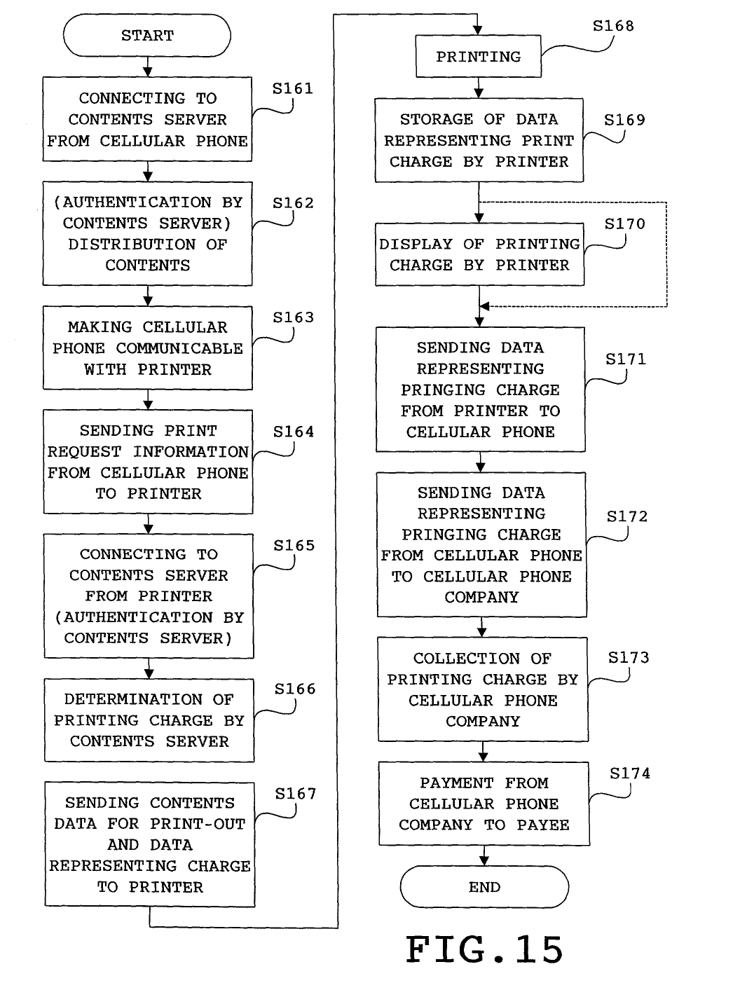

FIG. 15 is a flowchart for explaining the operation of the printing system according to the fourth embodiment of the present invention. The physical structure of the printing system according to this embodiment is substantially the same as that of the printing system according to the first embodiment. The printing charge determination data is stored in the contents server 30, as so in the third embodiment.

In this printing system, the process steps from the beginning to the printing of the contents data, and to the storage of the printing charge data by the MFP printer 20 are performed by following the same steps as steps S141 to S149 of the third embodiment (steps S161 to S169).

Then, the MFP printer 20 displays the printing charge represented by the data stored therein (step S170). However, this step may be omitted.

The MFP printer 20 sends the data representing the printing charge to the cellular phone 10 (step S171).

The cellular phone 10 receives the data sent from the MFP printer 20, and sends the data to the cellular phone company at a timing which meets a predetermined condition (step S172). Specifically, the data may be sent to the cellular phone company at a predetermined time, or immediately after the cellular phone 10 receives the data.

The cellular phone company records the printing charge user by user. And later on, the cellular phone company collects the total charges including the printing charge and the basic charge on behalf of the printing function provider, together with the communication charge (step S173). The cellular phone company pays the amount obtained by subtracting a predetermined commission from the collected total charges to predetermined payees such as the printing function provider and the shop installing the MFP printer 20 (step S174).

Fifth Embodiment

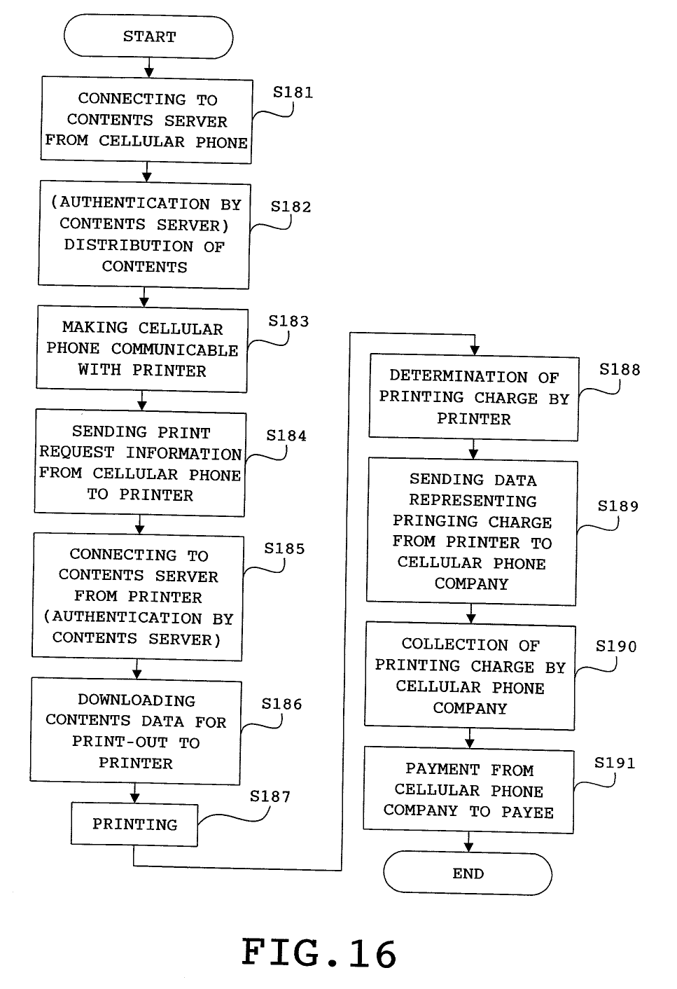

FIG. 16 is a flowchart for explaining the operation of the printing system according to the fifth embodiment of the present invention. The physical structure of the printing system according to this embodiment is substantially the same as that of the printing system according to the first embodiment. However, the printing charge determination data is stored in the MFP printer 20, as it is stored in the MFP printer 20 of the first embodiment, so that the determination of the printing charge is executed by the MFP printer 20.

In this printing system, the process steps from the beginning to the determination of the printing charge by the MFP printer 20 are performed by following the same steps as steps S1 0 1 to S108 of the first embodiment (steps S181 to S188).

Then, the MFP printer 20 connects to the server (not shown) operated by the cellular phone company. This connection is performed, for example, via the Internet 50. The MFP printer 20 sends to this server, the data representing the printing charge, and the user's ID and password stored in association with each other (step S189).

The cellular phone company collects the total charges including the basic charge and the printing charge represented by the data sent from the MFP printer 20 on behalf of the printing function provider, together with the communication charge (step S190). The cellular phone company pays the amount obtained by subtracting a predetermined commission from the collected total charges to a predetermined account (for example, the account of the printing function provider) (step S191).

In the second to fifth embodiments, the charge system is not limited to the above. The cellular phone company may collect the amount to be paid to the printing function provider, by separately collecting the basic charge, and charges determined by the number of sheets used, as explained so far. Or, charges may be collected completely by the number of sheets used.

The method by which the cellular phone company collects the basic charge and the printing charge on behalf of the printing function provider is based on the following conception. The printing function provider requires a charge for the right to use this printing system based on an agreement with the cellular phone company, just as a charge-requiring site requires a charge for its use. For example, to browse a charge-requiring contents on an official site authenticated by NTT DoCoMo Inc. in the i-mode™ service, a user close a predetermined contract with NTT DoCoMo Inc. in advance, as described above in Description of the Related Art. Then, NTT DoCoMo Inc. collects from the user, a monthly basic charge for browsing the user's desired charge-requiring site. NTT DoCoMo Inc. subtracts a predetermined commission from the collected charge, and pays the remainder to the contents provider 40. Just like this, also in case of this printing system, the user and the cellular phone company close a contract, and the user pays a predetermined basic charge to the cellular phone company based on this contract. Due to this payment, the user can use this printing system from anywhere by additional payment of the printing charge. However, there are many possible methods for collecting the basic charge and the printing charge other than this one.

In the first to fifth embodiments, the cellular phone company or the shop that has collected the printing charge uses some of the collected printing charge for maintenance of the MFP printers 20, and pays a predetermined performance charge (P/C) to, for example, a company that has sold the MFP printer 20. The P/C is set at, for example, 3.5 cents per sheet for monochrome printing, and 25 cents per sheet for color printing.

The structure of the printing system is not limited to the above described ones. For example, the cellular phone 10 may store electronic money in advance. The electronic money is data representing a monetary value. In this case, the cellular phone 10 may send some electronic money corresponding to the printing charge to the server (not shown) operated by the cellular phone company via the Internet 50. The cellular phone 10 may send some electronic money corresponding to the amount to be paid to the printing function provider to the contents provider 40 via a network.

In this case, the MFP printer 20 or the contents server 30 may inform the cellular phone 10 of the determined printing charge via the Internet 50. The cellular phone 10 may determine the amount of the electronic money to be paid to the server of the cellular phone company, and the amount of the electronic money to be paid to the contents provider 40 based on the informed printing charge.

The MFP printer 20 or the contents server 30 may determine the amount of the electronic money to be paid to the server of the cellular phone company by the cellular phone 10 and the amount of the electronic money to be paid to the contents provider 40 by the cellular phone 10, based on the determined printing charge, and may inform the cellular phone 10 of the determined amounts of electronic money. In this case, the cellular phone 10 may send the informed amounts of the electronic money to the server of the cellular phone company and to the contents provider 40.

The cellular phone 10 may send the electronic money together with the print request information to the MFP printer 20. In this case, the MFP printer 20 may receive the electronic money sent from the cellular phone 10, transfer some electronic money corresponding to the printing charge to the server of the cellular phone company via the Internet 50, and return the remainder to the cellular phone 10.

When the MFP printer 20 receives the electronic money from the cellular phone 10, the MFP printer 20 may transfer the received electronic money to the contents server 30. Then, the contents server 30 may transfer some electronic money corresponding to the printing charge to the server of the cellular phone company via the Internet 50, and return the remainder to the cellular phone 10.

The embodiment of the present invention has been explained as above. The printing system of the present invention can be realized not by a dedicated system, but by an ordinary computer system. The printing system which performs the above-described process can be realized by installing a program for performing the above actions of the contents server 30 in a computer which is connectable to a cellular phone and connected to an MFP printer, from a recording medium (a flexible disk, a CD-ROM, and the like) which stores the above program.

The program may be posted on a bulletin board (BBS) in a communication network, and distributed through the communication network. Or, a carrier wave may be modulated by a signal representing this program, and the obtained modulated wave may be transferred through a network. An apparatus which receives this modulated wave may demodulate the modulated wave to restore the program.

The above-described process can be carried out by starting this program, and executing this program under the control of OS, just as executing other application programs.

In a case where OS takes some part of the process, or in a case where OS constitutes a part of a factor of the present invention, a program which does not include such a part may be stored in a recording medium to be installed in a computer. According to the present invention, in this case, too, a program for controlling a computer to execute functions or steps is stored in this recording medium.

As obvious from the above explanation, according to the present invention, in a printing system in which a printing apparatus carries out printing by acquiring print data in accordance with print request information sent from a portable terminal, a system and a method for imposing a printing charge on a user is realized. According to such a system and a method, since a cellular phone company imposes a predetermined basic charge on a user on behalf of a printing function provider, it is very convenient for the user. A provider of a printer, a printing function provider, and a cellular phone company can do a profitable business with such a system and a method.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2000-305946 filed on Oct. 5, 2000, and including specification, claims, drawings and summary. The disclosure of the above Japanese Patent Application is incorporated herein by reference in its entirety.

What is claimed is:

1. A printing charge imposing method applicable to a printing system comprising a portable terminal; a printer capable of communicating data with said portable terminal and connected to a network, said printer including a display device for displaying data, and a charge collecting device for obtaining money inserted thereto; and a contents server capable of communicating data with said printer via said network, wherein; in a case where a user intends to print out contents data of said contents server which the user browses using said portable terminal, said portable terminal sends print request information for requesting print-out of the contents data to said printer; and said printer connects to said contents server via said network in accordance with the print request information, and acquires and prints out corresponding contents data for print-out, said method comprising the steps of:
pre-storing printing charge determination data for determining a printing charge;
determining the printing charge based on the printing charge determination data in accordance with that the contents data for print-out sent from the contents server has been printed out;
displaying the determined printing charge on said display device; and
obtaining money corresponding to the printing charge displayed on said display device, when such money is inserted to said charge collecting device.

2. A printing charge imposing method applicable to a printing system comprising a portable terminal; a printer capable of communicating data with said portable terminal and connected to a network; and a contents server capable of communicating data with said printer via said network, wherein; in a case where a user intends to print out contents data of said contents server which the user browses using said portable terminal, said portable terminal sends print request information for requesting print-out of the contents data to said printer; and said printer connects to said contents server via said network in accordance with the print request information, and acquires and prints out corresponding contents data for print-out, said method comprising the steps of:
pre-storing printing charge determination data for determining a printing charge;
determining the printing charge based on the printing charge determination data in accordance with that the contents data for print-out sent from said contents server has been printed out;
sending data representing the determined printing charge to said portable terminal;
imposing the printing charge represented by the data sent to said portable terminal on the user of said portable terminal together with a communication charge; and
paying an amount obtained by subtracting a predetermined commission from the printing charge to a predetermined payee.

3. A printing charge imposing method applicable to a printing system comprising a portable terminal; a printer capable of communicating data with said portable terminal and connected to a network; and a contents server capable of communicating data with said printer via said network, wherein; in a case where a user intends to print out contents data of said contents server which the user browses using said portable terminal, said portable terminal sends print request information for requesting print-out of the contents data to said printer; and said printer connects to said contents server via said network in accordance with the print request information, and acquires and prints out corresponding contents data for print-out, said method comprising the steps of:
pre-storing printing charge determination data for determining a printing charge;
determining the printing charge based on the printing charge determination data in accordance with that the contents data for print-out sent from said contents server has been printed out,
sending data representing the determined printing charge to said printer;
imposing the printing charge represented by the data sent to said printer on the user of said portable terminal together with a communication charge; and
paying an amount obtained by subtracting a predetermined commission from the printing charge to a predetermined payee.

4. A printing charge imposing method applicable to a printing system comprising a portable terminal; a printer capable of communicating data with, and transferring data to said portable terminal, and connected to a network; and a contents server capable of communicating data with said printer via said network, wherein; in a case where a user intends to print out contents data of said contents server which the user browses using said portable terminal, said portable terminal sends print request information for requesting print-out of the contents data to said printer; and said printer connects to said contents server via said network in accordance with the print request information, and acquires and prints out corresponding contents data for print-out, said method comprising the steps of:
pre-storing printing charge determination data for determining a printing charge;
determining the printing charge based on the printing charge determination data in accordance with that the contents data for print-out sent from said contents server has been printed out;
sending data representing the determined printing charge to said printer;
imposing the printing charge represented by the data which has been transferred from said printer to said portable terminal on the user of said portable terminal together with a communication charge; and
paying an amount obtained by subtracting a predetermined commission from the printing charge to a predetermined payee.

5. A printing charge imposing method applicable to a printing system comprising a portable terminal; a printer capable of communicating data with said portable terminal and connected to a network; and a contents server capable of communicating data with said printer via said network, wherein; in a case where a user intends to print out contents data of said contents server which the user browses using said portable terminal, said portable terminal sends print request information for requesting print-out of the contents data to said printer; and said printer connects to said contents server via said network in accordance with the print request information, and acquires and prints out corresponding contents data for print-out, said method comprising the steps of:
pre-storing printing charge determination data for determining a printing charge; and
determining the printing charge based on the printing charge determination data in accordance with that the contents data for print-out sent from said contents server has been printed out;
imposing the determined printing charge on the user of said portable terminal together with a communication charge; and
paying an amount obtained by subtracting a predetermined commission from the printing charge to a predetermined payee.

6. The method according to one of claims 1, comprising the steps of:
sending information for requesting supply of the contents data which the user desires, and ID information and password information both given to the user to said contents server, when the user intends to browse contents represented by the contents data;
authenticating the user based on the ID information and password information sent to said contents server;
searching out contents data for browsing which represents the user's desired contents, and sending it to the cellular phone, in a case where authentication is successful;
displaying the contents represented by the contents data for browsing sent to said cellular phone;
sending the print request information including a URL (Uniform Resource Locator) specifying the contents data for print-out which represents the displayed contents to said printer;
sending information for requesting supply of the contents data for print-out, and user's ID information and password information to said contents server, in accordance with the print request information;
authenticating the user again based on the user's ID information and password information sent to said contents server;
sending the contents data for print-out to said printer, in a case where authentication is successful; and
printing out the contents represented by the content data for print-out sent to said printer.

7. A printing charge imposing method for imposing a printing charge required for printing a contents utilizing a printing system which comprises a portable terminal; a contents server which stores contents data for browsing and contents data for print-out both representing a contents; and a printer having a charge collecting device for obtaining money inserted thereto, and a function for displaying data, said method comprising the steps of:
pre-storing printing charge determination data which represents a printing charge per sheet;
when said portable terminal, which has been supplied with said contents data for browsing from said contents server, sends print request information for requesting print-out of said contents data for print-out in accordance with a user's operation, acquiring the content data for print-out from said contents server in accordance with the print request information;
printing out the contents represented by said contents data for print-out;
determining the printing charge based on the printing charge determination data;
displaying the determined printing charge on said printer; and
obtaining money corresponding to the printing charge displayed on said printer, when such money is inserted to said charge collecting device.

8. A printing charge imposing method for imposing a printing charge required for printing a contents utilizing a printing system which comprises a portable terminal; a contents server which stores contents data for browsing and contents data for print-out both representing a contents; and a printer, said method comprising the steps of:
pre-storing printing charge determination data which represents a printing charge per sheet;
when said portable terminal, which has been supplied with said contents data for browsing from said contents server, sends print request information for requesting print-out of said contents data for print-out in accordance with a user's operation, acquiring the content data for print-out from said contents server in accordance with the print request information;
printing out the contents represented by said contents data for print-out;
determining the printing charge based on the printing charge determination data; and
imposing the determined printing charge together with a communication charge on the user of said portable terminal.

9. The method according to claim 8, comprising the steps of:
sending data representing the determined printing charge to said portable terminal; and
imposing the printing charge represented by the data sent to said portable terminal together with the communication charge on the user of said portable terminal.

10. The method according to claim 9, comprising the step of sending the data representing the printing charge to said portable terminal via said printer.

11. The method according to claim 8, comprising the steps of:
sending data representing the determined printing charge to said printer; and
imposing the printing charge represented by the data sent to said printer together with a communication charge on the user of said portable terminal.

12. The method according to one of claims 7, comprising the steps of:
sending authentication information given to the user to said contents server;
authenticating the user based on the authentication information; and
supplying the contents data for browsing to said portable terminal, or the contents data for print-out to said printer, when authentication is successful.

13. A printing system comprising: a portable terminal; a contents server which stores contents data for browsing and contents data for print-out both representing a contents; and a printer, wherein:
said printer has a printing function for printing out the contents represented by the contents data for print-out, when acquiring the contents data for print-out from said contents server in accordance with print request information which said printer receives and is for requesting print-out of the contents data for print-out;
said portable terminal sends the print request information to said printer in accordance with a user's operation, in a case where said contents server supplies the contents data for browsing to said portable terminal;
said contents server supplies the contents data for browsing to said portable terminal; and
said printer or said contents server stores printing charge determination data which represents a printing charge per sheet, and determines a printing charge based on the printing charge determination data.

14. The system according to claim 13, wherein:
said printer stores the printing charge determination data which represents a printing charge per sheet, and determines the printing charge based on the printing charge determination data; and
said printer comprises a display device for displaying the determined printing charge, and a charge collecting device for obtaining money corresponding to the displayed printing charge, when such money is inserted thereto.

15. The system according to claim 13, wherein:
said printer stores the printing charge determination data, determines the printing charge based on the printing charge determination data, and sends data representing the determined printing charge to said portable terminal; and
said portable terminal receives the data representing the printing charge sent from said printer, and sends it to the outside.

16. The system according to claim 13, wherein:
said contents server stores the printing charge determination data, determines the printing charge based on the printing charge determination data, and sends data representing the determined printing charge to said printer; and
said printer receives the data representing the printing charge sent form said contents server, and sends it to the outside.

17. The system according to claim 13, wherein:
said contents server stores the printing charge determination data, determines the printing charge based on the printing charge determination data, and sends data representing the determined printing charge to said printer;
said printer receives the data representing the printing charge sent from said contents server, and sends it to said portable terminal; and
said portable terminal receives the data representing the printing charge sent from said printer, and sends it to the outside.

18. The system according to one of claims 13, wherein:
said portable terminal sends authentication information given to the user to said contents server;
said contents server authenticates the user based on the authentication information, and supplies the contents data for browsing to said portable terminal, in a case where authentication is successful;
said printer sends the authentication information given to the user to said contents server; and
said contents server authenticates the user based on the authentication information, and supplies the contents data for print-out to said printer, in a case where authentication is successful.

19. A contents server comprising:
a memory which stores printing charge determination data representing a printing charge per sheet imposed on a user of a portable terminal for printing out a contents, and contents data for browsing and contents data for print-out both representing a contents;
a first control circuit which supplies the contents data for browsing to said portable terminal; and
a second control circuit which supplies the contents data for print-out to a printer in accordance with information sent from said printer for requesting supply of the contents data for print-out, and determines a printing charge required for printing out the contents represented by the contents data for print-out based on the printing charge determination data.

20. The contents server according to claim 19, further comprising a third control circuit which generates data representing the determined printing charge, and sends the generated data to said printer.

21. A printer comprising:
a first control circuit which acquires contents data for print-out representing a contents from an external contents server which stores the contents data for print-out, when supplied with print request information for requesting print-out of the contents data for print-out;
a printer head which prints out the contents represented by the contents data for print-out acquired by said first control circuit;
a memory which stores printing charge determination data which represents a printing charge per sheet; and
a second control circuit which determines a printing charge based on the printing charge determination data stored in said memory.

22. The printer according to claim 21, further comprising:
a display device which displays the determined printing charge; and
a charge collecting device which obtains money corresponding to the printing charge displayed on said display device, when such money is inserted thereto.

23. A computer data signal embedded in a carrier wave, and representing a program for controlling a computer to function as:
a memory which stores printing charge determination data representing a printing charge per sheet required for printing out a contents, and contents data for browsing and contents data for print-out both representing a contents;
a first control circuit which supplies the contents data for browsing to a portable terminal; and
a second control circuit which supplies the contents data for print-out to a printer in accordance with information sent from said printer for requesting supply of the contents data for print-out, and determines a printing charge required for printing out the contents represented by the contents data for print-out based on the printing charge determination data.

24. A computer data signal embedded in a carrier wave, and representing a program for controlling a computer having a printer head for printing out data to function as:
a first control circuit which acquires contents data for print-out representing a contents from an external contents server which stores the contents data for print-out, when supplied with print request information for requesting print-out of the contents data for print-out;
a printer head which prints out the contents represented by the contents data for print-out acquired by said first control circuit;
a memory which stores printing charge determination data which represents a printing charge per sheet; and
a second control circuit which determines a printing charge based on the printing charge determination data stored in said memory.
